(19) United States
(12) Patent Application Publication
(10) Pub. No.: US 2017/0330706 A1
(43) Pub. Date: Nov. 16, 2017

(54) KEY STRUCTURE

(71) Applicant: PRIMAX ELECTRONICS LTD., Taipei (TW)

(72) Inventors: Yi-Te Chou, Taipei (TW); Yi-Chen Wang, Taipei (TW); Che-Wei Yang, Taipei (TW)

(21) Appl. No.: 15/220,185

(22) Filed: Jul. 26, 2016

(30) Foreign Application Priority Data
May 13, 2016 (TW) 105114924

(51) Int. Cl. H01H 13/14; H01H 13/52

(52) U.S. Cl. CPC H01H 13/14; H01H 13/52

(57) ABSTRACT

A key structure includes a supporting plate, a movable plate, a keycap and a limiting structure. The supporting plate has supporting plate opening. The movable plate has a movable plate opening. The supporting plate is disposed over the movable plate. The keycap is disposed over the supporting plate. The limiting structure is disposed on the keycap and inserted in the supporting plate opening. When the movable plate is moved to a disabled position, the limiting structure is not aligned with the movable plate opening and the limiting structure in the supporting plate opening is stopped by the movable plate. Consequently, the keycap is not allowed to be moved.

### FIELD OF THE INVENTION

The present invention relates to a key structure, and more particularly to a key structure having a function of avoiding erroneous operations.

### BACKGROUND OF THE INVENTION

Generally, the widely-used peripheral input device of a computer system includes for example a mouse, a keyboard, a trackball, or the like. Via the keyboard, characters or symbols can be directly inputted into the computer system. As a consequence, most users and most manufacturers of input devices pay much attention to the development of keyboards. As known, a keyboard with scissors-type connecting elements is one of the widely-used keyboards.

FIG. 1 is a schematic perspective view illustrating the structure of a conventional notebook computer. As shown in FIG. 1, the conventional notebook computer 1 comprises a keyboard base 10, a top cover 11, a rotary shaft 12 and a keyboard 13. The top cover 11 comprises a display screen 111. The top cover 11 is rotatable through the rotary shaft 12. Consequently, the top cover 11 is closed to cover the keyboard base 10, or the top cover 11 is uplifted to allow the notebook computer 1 to be in a usage status. The keyboard 13 is installed on the keyboard base 10. When the keyboard 13 is operated by the user, a corresponding key signal is generated. Meanwhile, the notebook computer 1 is in a laptop mode.

The key structure of the keyboard 13 will be illustrated as follows. For succinctness, only one key structure is shown. FIG. 2 is a schematic side cross-sectional view illustrating a key structure of a conventional keyboard. As shown in FIG. 2, the conventional key structure 130 of the keyboard 13 comprises a keycap 1301, a scissors-type connecting element 1302, a rubbery elastomer 1303, a membrane switch circuit member 1304 and a base plate 1305. The keycap 1301, the scissors-type connecting element 1302, the rubbery elastomer 1303 and the membrane switch circuit member 1304 are supported by the base plate 1305. The scissors-type connecting element 1302 is used for connecting the base plate 1305 and the keycap 1301.

The scissors-type connecting element 1302 is arranged between the base plate 1305 and the keycap 1301, and the base plate 1305 and the keycap 1301 are connected with each other through the scissors-type connecting element 1302. The rubbery elastomer 1303 is enclosed by the scissors-type connecting element 1302. The membrane switch circuit member 1304 comprises plural key intersections (not shown). When one of the plural key intersections is triggered, a corresponding key signal is generated.

The rubbery elastomer 1303 is disposed on the membrane switch circuit member 1304. Each rubbery elastomer 1303 is aligned with a corresponding key intersection. When the rubbery elastomer 1303 is depressed, the rubbery elastomer 1303 is subjected to deformation to push the corresponding key intersection of the membrane switch circuit member 1304. Consequently, the corresponding key signal is generated.

The operations of the conventional key structure 130 in response to the depressing action of the user will be illustrated as follows. Please refer to FIG. 2 again. While the keycap 1301 is depressed, the keycap 1301 is moved downwardly to push the scissors-type connecting element 1302 in response to the depressing force. As the keycap 1301 is moved downwardly relative to the base plate 1305, the keycap 1301 pushes the corresponding rubbery elastomer 1303. At the same time, the rubbery elastomer 1303 is subjected to deformation to push the membrane switch circuit member 1304 and trigger the corresponding key intersection of the membrane switch circuit member 1304. Consequently, the membrane switch circuit member 1304 generates a corresponding key signal. When the keycap 1301 is no longer depressed by the user, no external force is applied to the keycap 1301 and the rubbery elastomer 1303 is no longer pushed by the keycap 1301. In response to the elasticity of the rubbery elastomer 1303, the rubbery elastomer 1303 is restored to its original shape to provide an upward elastic restoring force. In response to the elastic restoring force, the keycap 1301 is returned to its original position where it is not depressed.

Recently, a touch device is introduced into the market. The touch device is operated by using the user's finger directly or using a touch pen. Since the touch device is easy to use, many users and many manufacturers pay much attention to the touch device. For example, the display screen 111 of the notebook computer 1 is a touch screen with a touch control function. Moreover, a notebook computer having an inversely foldable screen is introduced into the market. FIG. 3 is a schematic perspective view illustrating a conventional notebook computer having an inversely foldable screen, in which the notebook computer is in a tablet mode. After the top cover 11 of the notebook computer 1 is rotated in the direction toward a rear side of the keyboard base 10 through the rotary shaft 12, the top cover 11 is folded to be contacted with a rear surface of the keyboard base 10 and the display screen 111 is exposed. Meanwhile, the notebook computer 1 has the outer appearance of a touch device such as a tablet computer. Since the display screen 111 is a touch screen, the notebook computer 1 can be used as a touch device.

However, the keyboard 13 of the notebook computer 1 in the tablet mode is also exposed. Consequently, when the notebook computer 1 is held by the user's hands, the fingers of the user may press the key structures 130. Since the pressed key structures 130 are moved downwardly to form a concave region, it is difficult for the user to stably hold the notebook computer 1. Moreover, if the key structure 130 is erroneously triggered when the notebook computer 1 is held by the user's hands, the notebook computer 1 also generates a key signal. Under this circumstance, the erroneous operation is generated. In other words, the conventional key structure for the notebook computer having an inversely foldable screen is not user-friendly.

Therefore, there is a need of providing a key structure capable of avoiding erroneous operations in response to the changed appearance.

### SUMMARY OF THE INVENTION

The present invention provides a key structure having a function of avoiding erroneous operations.

In accordance with an aspect of the present invention, there is provided a key structure. The key structure includes a supporting plate, a movable plate, a keycap and a limiting structure. The supporting plate has supporting plate opening. The movable plate is disposed under the supporting plate, and movable relative to the supporting plate in a first direction. The movable plate has a movable plate opening corresponding to the supporting plate opening. The keycap is disposed over the supporting plate, and movable relative to the supporting plate in a second direction. The limiting structure is disposed on the keycap and inserted in the supporting plate opening. A movement of the keycap relative to the supporting plate in the second direction is limited by the limiting structure. When the movable plate is moved to a disabled position, the limiting structure is not aligned with the movable plate opening and the limiting structure in the supporting plate opening is stopped by the movable plate. Consequently, the keycap is not allowed to be moved in the second direction.

In accordance with another aspect of the present invention, there is provided a key structure. The key structure includes a supporting plate, a movable plate and a keycap. The supporting plate has a supporting plate opening. The movable plate is disposed under the supporting plate, and movable relative to the supporting plate in a first direction. The movable plate has a limiting structure. The limiting structure is disposed on the movable plate and inserted in the supporting plate opening. The keycap is disposed over the supporting plate, and movable relative to the supporting plate in a second direction. As the movable plate is moved, the limiting structure is correspondingly moved in the supporting plate opening. When the movable plate is moved to a disabled position, the limiting structure is contacted with the keycap, so that the keycap is not allowed to be moved in the second direction.

From the above descriptions, the present invention provides a key structure including a keycap, a limiting structure and a movable plate. The keycap is selectively moved or not moved according to the position of the limiting structure. Moreover, the function of the key structure is selectively enabled or disabled when the movable plate is moved to an enabled position or a disabled position. That is, the movement of the keycap is determined according to the practical requirements. When the notebook computer is in the tablet mode, even if the key structure is carelessly touched, the problem of causing erroneous operation is avoided.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the structure of a conventional notebook computer;

FIG. 2 is a schematic side cross-sectional view illustrating a key structure of a conventional keyboard;

FIG. 3 is a schematic perspective view illustrating a conventional notebook computer having an inversely foldable screen, in which the notebook computer is in a tablet mode;

FIG. 4 is a schematic side cross-sectional view illustrating a notebook computer with key structures according to a first embodiment of the present invention;

FIG. 5 is a schematic exploded view illustrating a key structure according to the first embodiment of the present invention;

FIG. 6 is a schematic side cross-sectional view illustrating the key structure according to the first embodiment of the present invention, in which the key structure is in an enabled position;

FIG. 7 is a schematic side cross-sectional view illustrating the notebook computer with the key structures according to the first embodiment of the present invention, in which the movable plate is moved in the first direction;

FIG. 8 is a schematic side cross-sectional view illustrating the key structure according to the first embodiment of the present invention, in which the key structure is in a disabled position;

FIG. 9 is a schematic perspective view illustrating a notebook computer with key structures according to a second embodiment of the present invention;

FIG. 10 is a schematic exploded view illustrating a key structure according to the second embodiment of the present invention;

FIG. 11 is a schematic side cross-sectional view illustrating the key structure according to the second embodiment of the present invention, in which the key structure is in an enabled position;

FIG. 12 is a schematic side cross-sectional view illustrating the key structure according to the second embodiment of the present invention, in which the key structure is in a disabled position; and

FIG. 13 is a schematic side cross-sectional view illustrating the key structure according to a third embodiment of the present invention, in which the key structure is in an enabled position.

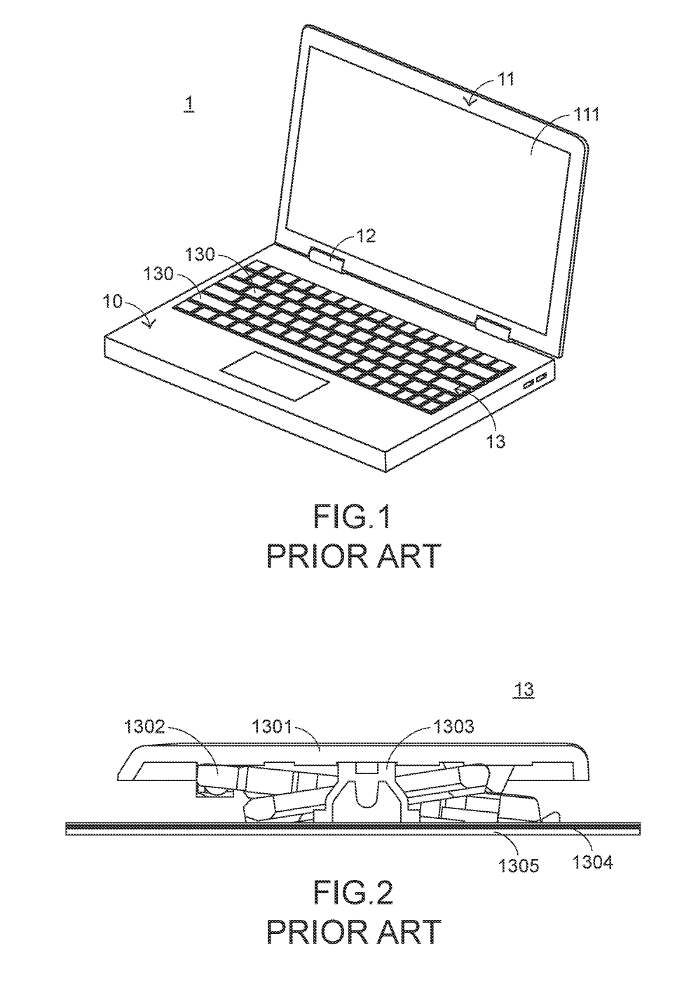

### DETAILED DESCRIPTION OF THE PREFERRED EMBODIMENT

For solving the drawbacks of the conventional technologies, the present invention provides a key structure having a function of avoiding erroneous operations.

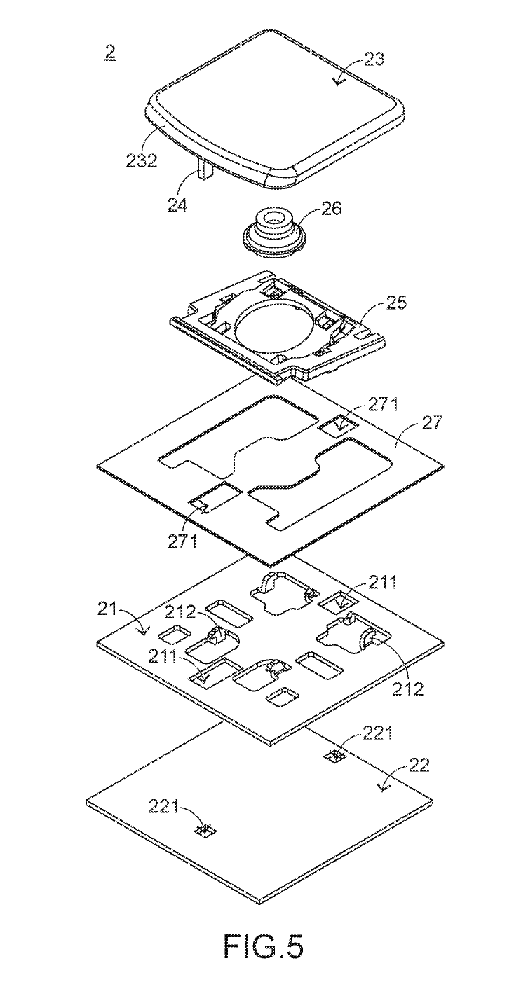

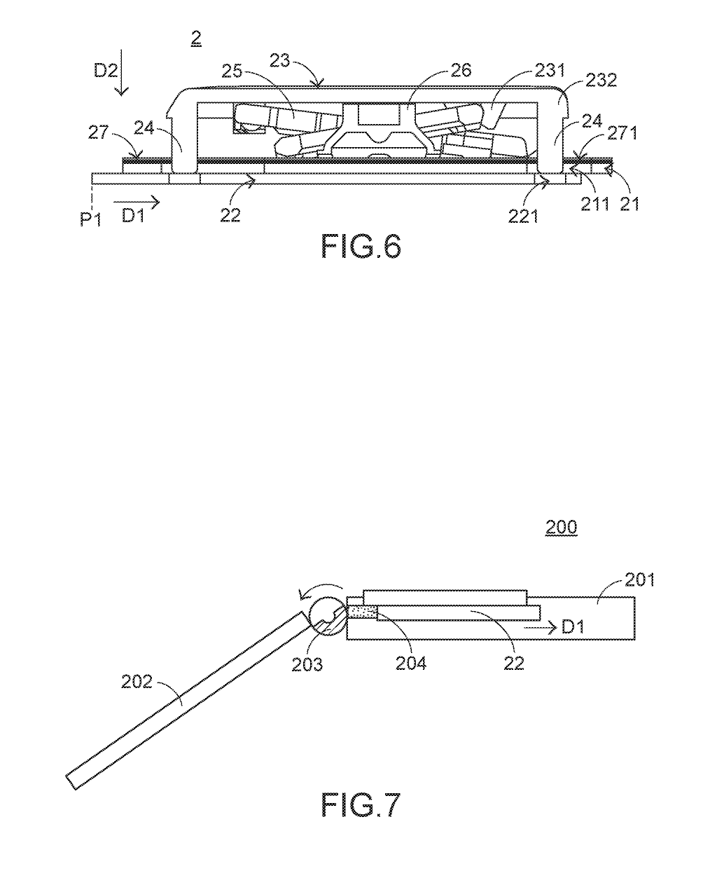

Please refer to FIGS. 4, 5 and 6. FIG. 4 is a schematic side cross-sectional view illustrating a notebook computer with key structures according to a first embodiment of the present invention. FIG. 5 is a schematic exploded view illustrating a key structure according to the first embodiment of the present invention. FIG. 6 is a schematic side cross-sectional view illustrating the key structure according to the first embodiment of the present invention, in which the function of the key structure is enabled. All components of the key structure 2 can be seen in FIG. 5. In this embodiment, the key structure 2 comprises a supporting plate 21, a movable plate 22, a keycap 23, plural limiting structures 24, a scissors-type connecting element 25, an elastic element 26 and a membrane switch circuit member 27. The movable plate 22 of the key structure 2 is installed in a keyboard base 201 of a notebook computer 200. The keyboard base 201 is connected with a top cover 202. A rotary shaft 203 is connected with the top cover 202 and a transmission mechanism 204. The top cover 202 is rotatable relative to the keyboard base 201 through the rotary shaft 203. As the top cover 202 is rotated to different positions, the transmission mechanism 204 is enabled to allow the notebook computer 200 to be in different operation modes. For example, in case that the top cover 202 is closed to cover the keyboard base 201, the notebook computer 200 is in a hibernation mode or a power-off mode. Whereas, in case that the top cover 202 is uplifted to expose the key structures 2, the notebook computer 200 is in a laptop mode. When the top cover 202 is inversely folded to be contacted with a rear surface of the keyboard base 201, the notebook computer 200 is in a tablet mode.

Please refer to FIGS. 5 and 6. The supporting plate 21 comprises plural supporting plate openings 211 and plural supporting plate hooks 212. The movable plate 22 is disposed under the supporting plate 21. Moreover, the movable plate 22 is movable relative to the supporting plate 21 in a first direction D1. The movable plate 22 comprises plural movable plate openings 221 corresponding to the supporting plate openings 211. The keycap 23 is disposed over the supporting plate 21. As the keycap 23 is depressed by the user, the keycap 23 is moved relative to the supporting plate 21 in a second direction D2. Moreover, the keycap 23 comprises plural keycap hooks 231. The plural limiting structures 24 are disposed on the keycap 23 and inserted in the corresponding supporting plate openings 211. The plural limiting structures 24 are used for limiting the movement of the keycap 23 relative to the supporting plate 21 in the second direction D2.

In this embodiment, the plural limiting structures 24 are protruded from the periphery of the keycap 23 toward the movable plate 22 (i.e., protruded downwardly from the periphery of the keycap 23). Preferably but not exclusively, the plural limiting structures 24 are integrally formed with the keycap 23. In another embodiment, the plural limiting structures are fixed on the keycap through an assembling means, an adhering means, an engaging means or any other appropriate coupling means.

The membrane switch circuit member 27 is disposed over the supporting plate 21. While the keycap 23 is moved downwardly to trigger the membrane switch circuit member 27, a key signal corresponding to the keycap 23 is generated. The membrane switch circuit member 27 comprises plural membrane openings 271 corresponding to the plural supporting plate openings 211. The plural limiting structures 24 are penetrated through the corresponding membrane openings 271 and the corresponding supporting plate openings 211. The elastic element 26 is arranged between the keycap 23 and the membrane switch circuit member 27. When the elastic element 26 is pushed by the keycap 24, the membrane switch circuit member 27 is triggered by the elastic element 26. Moreover, the elastic element 26 can provide an elastic force. In an embodiment, the elastic element 26 is a rubbery elastomer.

The scissors-type connecting element 25 is arranged between the keycap 23 and the membrane switch circuit member 27, and connected with the keycap 23 and the supporting plate 21. The scissors-type connecting element 25 is connected with the supporting plate 21 through the supporting plate hooks 212, and connected with the keycap 23 through the keycap hooks 231. Consequently, the scissors-type connecting element 25 is correspondingly moved with the keycap 23.

Hereinafter, the operations of the key structure 2 in response to the depressing action of the user will be illustrated with reference to FIG. 6. When the movable plate 22 is moved to an enabled position P1 in the first direction D1, the plural limiting structures 24 are aligned with the corresponding movable plate openings 221. Consequently, the limiting structures 24 in the corresponding supporting plate openings 211 are allowed to be inserted in the corresponding movable plate openings 221. Under this circumstance, the keycap 23 is movable in the second direction D2.

In the situation of FIG. 6, the function of the key structure 2 is enabled. While the keycap 23 is depressed, the keycap 23 is moved in the second direction D2 in response to the depressing force and the scissors-type connecting element 25 is correspondingly swung. Moreover, the limiting structures 24 are inserted in the corresponding supporting plate openings 211 and the corresponding movable plate openings 221. As the keycap 23 is moved downwardly to push the corresponding elastic element 26, the elastic element 26 is subjected to deformation to press the membrane switch circuit member 27 and trigger the corresponding key intersection (not shown) of the membrane switch circuit member 27. Consequently, the membrane switch circuit member 27 generates a corresponding key signal.

When the keycap 23 is no longer depressed by the user, no external force is applied to the keycap 23 and the elastic element 26 is no longer pushed by the keycap 23. In response to the elasticity of the elastic element 26, the elastic element 26 is restored to its original shape to provide an upward elastic restoring force to the keycap 23. As the keycap 23 is moved upwardly, the scissors-type connecting element 25 is correspondingly swung. Consequently, the keycap 23 is returned to its original position where it is not depressed (see FIG. 6). Meanwhile, the limiting structures 24 are escaped from the corresponding movable plate openings 221.

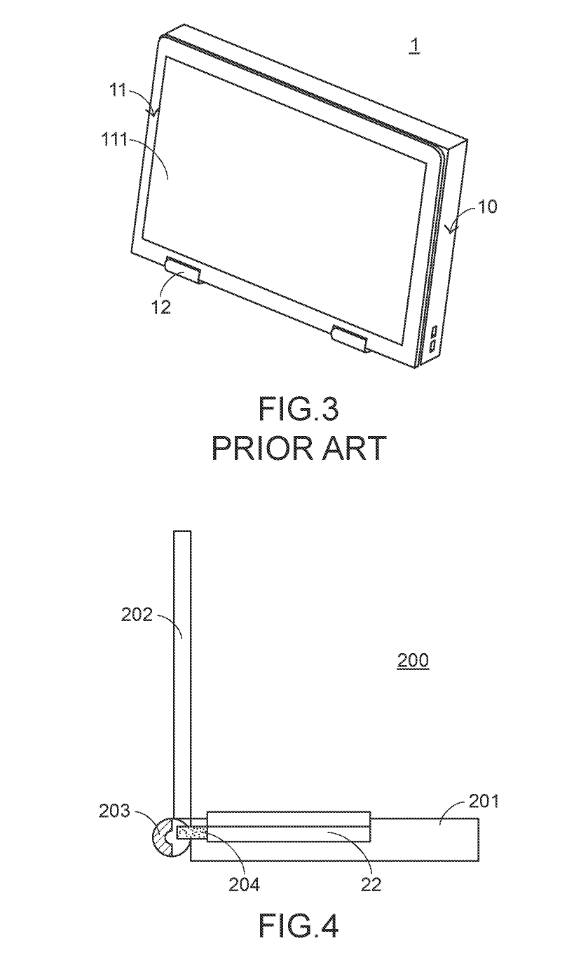

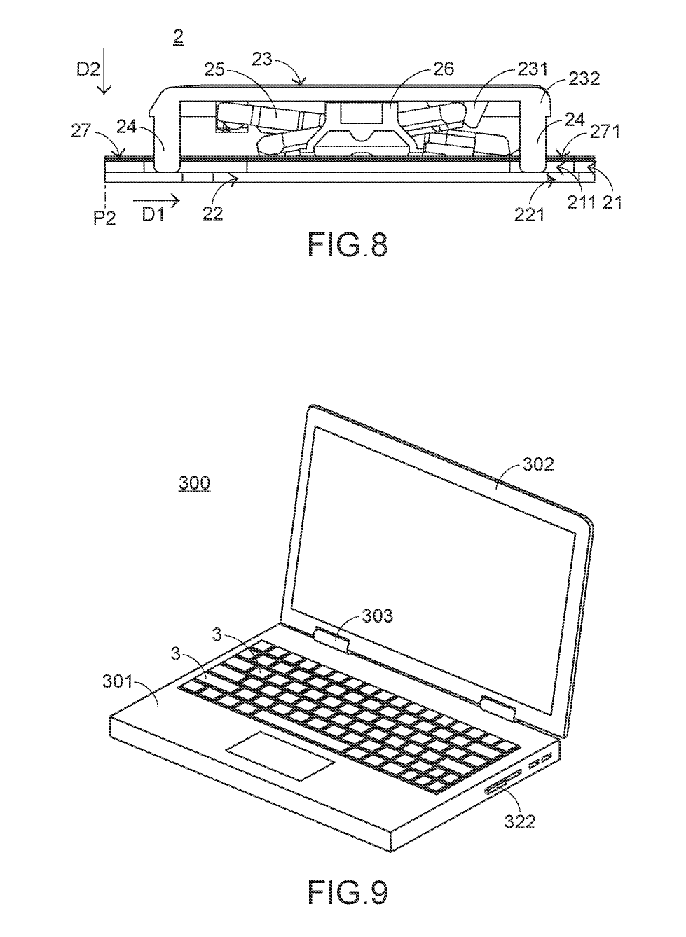

Hereinafter, a process of changing the appearance of the notebook computer 200 to switch the state of the key structure 2 will be illustrated with reference to FIGS. 4, 6, 7 and 8. FIG. 7 is a schematic side cross-sectional view illustrating the notebook computer with the key structures according to the first embodiment of the present invention, in which the movable plate is moved in the first direction. FIG. 8 is a schematic side cross-sectional view illustrating the key structure according to the first embodiment of the present invention, in which the key structure is in a disabled position. As shown in FIG. 4, the transmission mechanism 204 is connected with the movable plate 22. For switching the operation mode of the notebook computer 200 from the laptop mode to the tablet mode (see FIG. 3), the top cover 202 is folded in a counterclockwise direction to allow the top cover 202 to be contacted with the rear surface of the keyboard base 201. While the top cover 202 is folded in the counterclockwise direction, the rotary shaft 203 is rotated to push the transmission mechanism 204 and thus the transmission mechanism 204 is moved in the first direction D1 to push the movable plate 22. As the movable plate 22 is moved relative to the supporting plate 21 in the first direction D1, the function of the key structure 2 is gradually disabled (see FIG. 8).

As mentioned in FIG. 6, the limiting structures 24 are aligned with the corresponding movable plate openings 221 when the movable plate 22 is in the enabled position P1. Please refer to FIG. 8. When the movable plate 22 is moved to a disabled position P2 in the first direction D1, the plural limiting structures 24 are not aligned with the corresponding movable plate openings 221. Under this circumstance, the limiting structures 24 in the supporting plate openings 211 are stopped by the movable plate 22, and the keycap 23 fails to be moved in the second direction D2. When the notebook computer 200 is in the tablet mode, the limiting structures 24 on the keycap 23 are stopped by the movable plate 22. Consequently, the limiting structures 24 cannot be descended. Even if the keycap 23 is depressed by the user at this moment, the keycap 23 is not moved downwardly. As a consequence, the problem of causing erroneous operation is avoided.

For switching the operation mode of the notebook computer 200 from the tablet mode to the laptop mode, the rotary shaft 203 is rotated to push the transmission mechanism 204. Consequently, the transmission mechanism 204 is moved in a direction opposed to the first direction D1 to push the movable plate 22. When the movable plate 22 is returned to the enabled position P1, the function of the key structure 2 is enabled again (see FIG. 6).

In the above embodiment, the elastic element 26 is a component of the key structure 2 for returning the keycap 23 in the vertical direction. It is noted that the component for returning the keycap 23 in the vertical direction is not restricted. For example, in another embodiment, the key structure further comprises two magnetic elements. One of the magnetic elements is installed on the keycap, and the other magnetic element is installed on the supporting plate or the membrane switch circuit member. While the keycap is depressed, the two magnetic elements interact with each other to generate a repulsive force. In response to the repulsive force, the keycap is moved upwardly and returned to its original position. However, in this case, a protrusion structure is formed on an inner surface of the keycap to trigger the membrane switch circuit member.

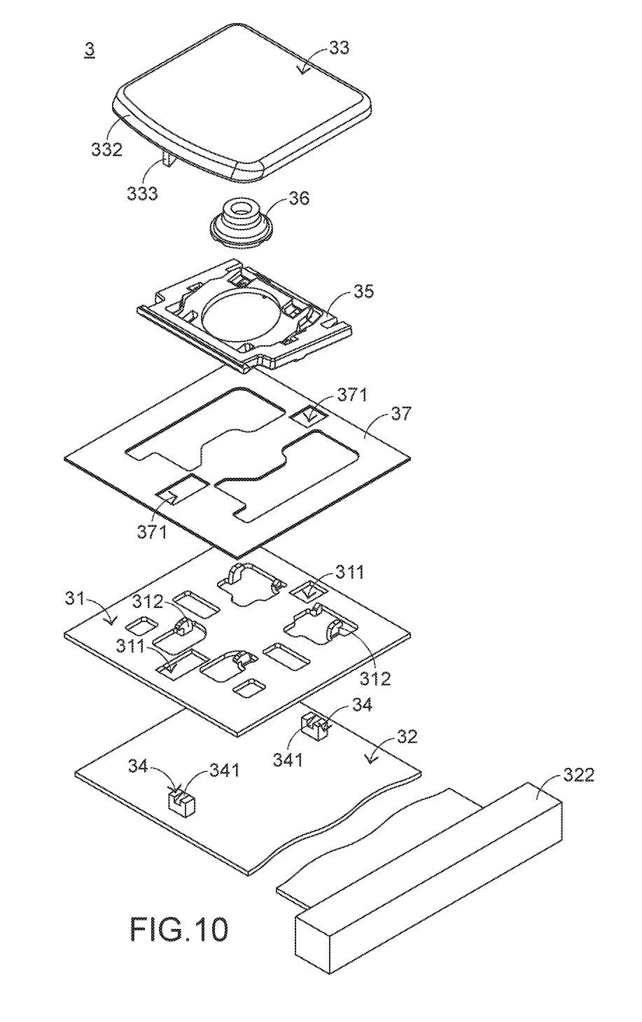

The present invention further provides a second embodiment, which is distinguished from the first embodiment. Please refer to FIGS. 9 and 10. FIG. 9 is a schematic perspective view illustrating a notebook computer with key structures according to a second embodiment of the present invention. FIG. 10 is a schematic exploded view illustrating a key structure according to the second embodiment of the present invention. All components of the key structure 3 can be seen in FIG. 10. In this embodiment, the key structure 3 comprises a supporting plate 31, a movable plate 32, a keycap 33, plural limiting structures 34, a scissors-type connecting element 35, an elastic element 36 and a membrane switch circuit member 37. The supporting plate 31 comprises plural supporting plate openings 311 and plural supporting plate hooks 312. The membrane switch circuit member 37 comprises plural membrane openings 371. The movable plate 32 of the key structure 3 is installed in a keyboard base 301 of a notebook computer 300. The keyboard base 301 is connected with a top cover 302. A rotary shaft 303 is connected with the top cover 302. As the top cover 302 is rotated relative to the keyboard base 301, the notebook computer 300 is in different operation modes. The structures and functions of the components of the key structure 3 which are identical to those of the first embodiment are not redundantly described herein. In comparison with the first embodiment, the key structure 3 of this embodiment has two distinguished aspects. Firstly, the structures of the keycap 33 and the limiting structures 34 are distinguished. Secondly, the operations of the movable plate 32 are distinguished.

The structures of the keycap 33 and the limiting structures 34 will be described as follows. As shown in FIG. 10, the limiting structures 34 are formed on the movable plate 32 rather than the periphery 332 of the keycap 33. Moreover, the movable plate 32 has no movable plate openings. The plural limiting structures 34 are disposed on the movable plate 32, and protruded from the movable plate 32 toward the keycap 33. Moreover, the plural limiting structures 34 are penetrated through the corresponding supporting plate openings 311. Each limiting structure 34 has a first contacting part 343. Similarly, the keycap 33 comprises plural keycap hooks 331. Moreover, the keycap 33 further comprises plural second contacting parts 333 corresponding to the plural first contacting parts 341. The plural second contacting parts 333 are disposed on the periphery 332 of the keycap 33. In this embodiment, the first contacting parts 341 and the corresponding second contacting parts 333 have complementary shapes. Moreover, each first contacting parts 341 and the corresponding second contacting part 333 are contact slant surfaces facing different directions.

Please refer to FIGS. 9 and 10 again. As shown in FIG. 10, the movable plate 32 further comprises a driving part 322. The driving part 322 is located at a lateral side of the movable plate 32 and exposed outside the keyboard base 301 of the notebook computer 300. While the driving part 322 is pressed or pushed by the user, the movable plate 32 is correspondingly moved in the first direction D1. An example of the driving part 322 includes but is not limited to a driving lever or a push button. That is, the movement of the movable plate 32 is not linked with the rotary shaft 303.

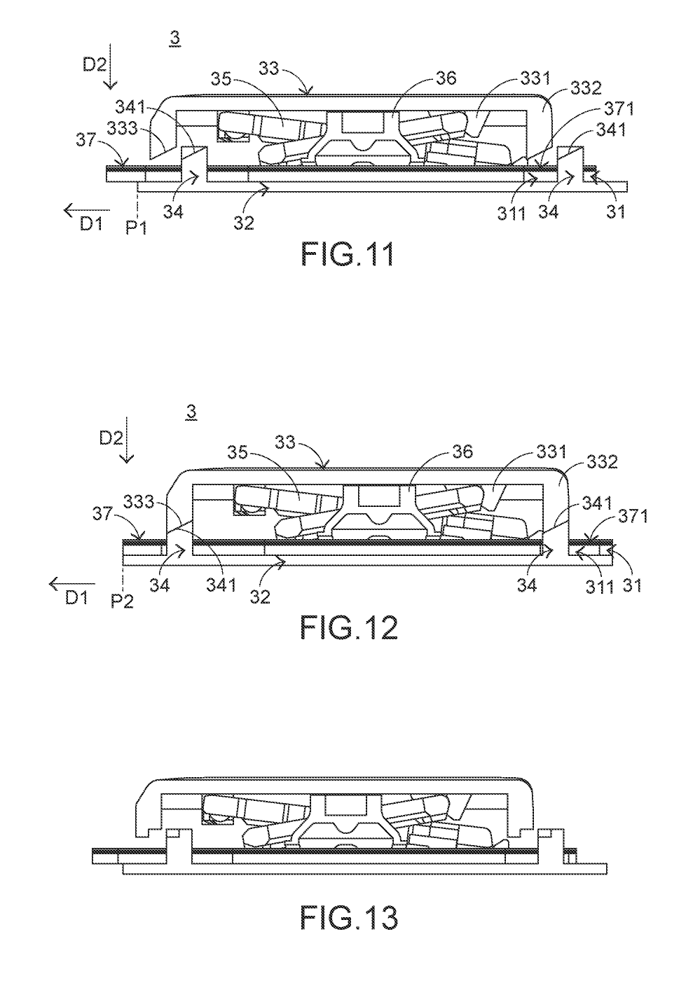

Hereinafter, a process of changing the appearance of the notebook computer 300 to switch the state of the key structure 3 will be illustrated with reference to FIGS. 9, 11 and 12. FIG. 11 is a schematic side cross-sectional view illustrating the key structure according to the second embodiment of the present invention, in which the key structure is in an enabled position. FIG. 12 is a schematic side cross-sectional view illustrating the key structure according to the second embodiment of the present invention, in which the key structure is in a disabled position. After the operation mode of the notebook computer 300 is switched to the tablet mode, the user may move the movable plate 32 relative to the supporting plate 31 in a first direction D1 through the driving part 322. Consequently, the function of the key structure 3 is disabled (see FIG. 12).

As the movable plate 32 is moved from an enabled position P1 toward a disabled position P2, the plural limiting structures 34 are moved in the corresponding supporting plate openings 311. When the movable plate 32 is moved to the disabled position P2, the plural first contacting parts 341 are contacted with the corresponding second contacting parts 333. Meanwhile, the limiting structures 34 are contacted with the keycap 33, and the keycap 33 is not allowed to be moved in a second direction D2. For switching the operation mode of the notebook computer 300 from the tablet mode to the laptop mode, the driving part 322 is pressed or pushed by the user again. Consequently, the movable plate 32 is moved in a direction opposed to the first direction D1. When the movable plate 32 is returned to the enabled position P1, the function of the key structure 3 is enabled again (see FIG. 11).

When the notebook computer 300 is in the tablet mode, the keycap 33 is stopped by the limiting structures 34, which is formed on the movable plate 32. Consequently, the keycap 33 cannot be descended. Even if the keycap 33 is depressed by the user at this moment, the keycap 33 is not moved downwardly. As a consequence, the problem of causing erroneous operation is avoided.

The first contacting parts 341 and the second contacting parts 333 of the key structure 3 are not restricted to contact slant surfaces. That is, the shapes of the first contacting parts and the second contacting parts may be varied according to the practical requirements. A variant example of the key structure is shown in FIG. 13. In this embodiment, the first contacting part and the corresponding second contacting part are bulges with complementary shapes.

From the above descriptions, the present invention provides a key structure. The key structure includes a keycap, a limiting structure and a movable plate. The keycap is selectively moved or not moved according to the position of the limiting structure. Moreover, the function of the key structure is selectively enabled or disabled when the movable plate is moved to an enabled position or a disabled position. That is, the movement of the keycap is determined according to the practical requirements. When the notebook computer is in the tablet mode, even if the key structure is carelessly touched, the problem of causing erroneous operation is avoided. In comparison with the conventional technologies, the key structure of the present invention has simpler structure and is easily operated. Consequently, the key structure of the present invention can solve the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A key structure, comprising:
a supporting plate having a supporting plate opening;
a movable plate disposed under the supporting plate, and movable relative to the supporting plate in a first direction, wherein the movable plate has a movable plate opening corresponding to the supporting plate opening;
a keycap disposed over the supporting plate, and movable relative to the supporting plate in a second direction; and
a limiting structure disposed on the keycap and inserted in the supporting plate opening, wherein a movement of the keycap relative to the supporting plate in the second direction is limited by the limiting structure, wherein when the movable plate is moved to a disabled position, the limiting structure is not aligned with the movable plate opening and the limiting structure in the supporting plate opening is stopped by the movable plate, so that the keycap is not allowed to be moved in the second direction.

2. The key structure according to claim 1, wherein when the movable plate is moved to an enabled position, the limiting structure is aligned with the movable plate opening and the limiting structure in the supporting plate opening is further inserted in the movable plate opening, so that the keycap is allowed to be moved in the second direction.

3. The key structure according to claim 1, wherein the limiting structure is protruded from a periphery of the keycap toward the movable plate.

4. The key structure according to claim 1, wherein the movable plate further comprises a driving part, and the driving part is located at a lateral side of the movable plate, wherein while the driving part is moved, the movable plate is correspondingly moved in the first direction.

5. The key structure according to claim 1, further comprising:
a membrane switch circuit member disposed over the supporting plate, wherein as the keycap is moved, a key signal corresponding to the keycap is generated by the membrane switch circuit member;
a scissors-type connecting element connected with the keycap and the supporting plate, wherein the keycap is fixed on the supporting plate through the scissors-type connecting element; and
an elastic element arranged between the keycap and the membrane switch circuit member, wherein when the elastic element is pushed by the keycap, the membrane switch circuit member is triggered by the elastic element, wherein when the keycap is no longer depressed, the elastic element provides an elastic force to the keycap, the keycap is moved in response to the elastic force, and the scissors-type connecting element is correspondingly swung.

6. A key structure, comprising:
a supporting plate having a supporting plate opening;
a movable plate disposed under the supporting plate, and movable relative to the supporting plate in a first direction, wherein the movable plate has a limiting structure, and the limiting structure is disposed on the movable plate and inserted in the supporting plate opening; and
a keycap disposed over the supporting plate, and movable relative to the supporting plate in a second direction, wherein as the movable plate is moved, the limiting structure is correspondingly moved in the supporting plate opening, wherein when the movable plate is moved to a disabled position, the limiting structure is contacted with the keycap, so that the keycap is not allowed to be moved in the second direction.

7. The key structure according to claim 6, wherein when the movable plate is moved to an enabled position, the limiting structure is not contacted with the keycap, so that the keycap is allowed to be moved in the second direction.

8. The key structure according to claim 6, wherein the limiting structure is protruded from a periphery of the movable plate toward the keycap, and a first contacting part of the limiting structure and a second contacting part of the keycap have complementary shapes.

9. The key structure according to claim 6, wherein the movable plate further comprises a driving part, and the driving part is located at a lateral side of the movable plate, wherein while the driving part is moved, the movable plate is correspondingly moved in the first direction.

10. The key structure according to claim 6, further comprising:
a membrane switch circuit member disposed over the supporting plate, wherein as the keycap is moved, a key signal corresponding to the keycap is generated by the membrane switch circuit member;
a scissors-type connecting element connected with the keycap and the supporting plate, wherein the keycap is fixed on the supporting plate through the scissors-type connecting element; and
an elastic element arranged between the keycap and the membrane switch circuit member, wherein when the elastic element is pushed by the keycap, the membrane switch circuit member is triggered by the elastic element, wherein when the keycap is no longer depressed, the elastic element provides an elastic force to the keycap, the keycap is moved in response to the elastic force, and the scissors-type connecting element is correspondingly swung.
